(19) United States
(12) Patent Application Publication
(10) Pub. No.: US 2023/0249322 A1
(43) Pub. Date: Aug. 10, 2023

(54) UNIVERSAL SCREW WRENCH AND ITS USE

(71) Applicant: SAMUEL KEVIN DE HOLANDA PEREIRA, TAGUATINGA (BR)

(72) Inventor: SAMUEL KEVIN DE HOLANDA PEREIRA, TAGUATINGA (BR)

(21) Appl. No.: 18/084,931

(22) Filed: Dec. 20, 2022

(30) Foreign Application Priority Data
Dec. 20, 2021 (BR) 1020210257431

(51) Int. Cl. B25B 15/00; B25B 15/02

(52) U.S. Cl. CPC B25B 15/002; B25B 15/02; B25B 23/12

(57) ABSTRACT

The present patent of privilege of invention belongs to the field of general purpose tools, and is more specifically a universal screwdriver, notably, it adapts to the most varied models of screws, allowing the user to use the same tool to screw or loosen the screws, saving the cost of obtaining different keys and also saving the space for storing the tools.

### TECHNICAL FIELD OF THE INVENTION

This patent for the privilege of invention belongs to the field of general purpose tools, and is more specifically a universal screwdriver, notably, it adapts to the most varied models of screws, allowing the user with the same tool can screw in or loosen screws, saving the cost of obtaining assorted wrenches and also saving the space to store the tools.

### HISTORY OF THE TECHNIQUE

The first documented screwdrivers were used in Europe in the late Middle Ages. The first documentation of the tool is in the medieval manuscript Housebook of Wolfegg Castle, which was written sometime between 1475 and 1490. These early wrenches had pear-shaped handles and were made for slotted screws (the diversification of the many wrench types). rift did not come about until the so-called Gilded Age). At first, she remained low-key; however, there is evidence of its existence over the next 300 years, based primarily on the presence of screws.

The tool is best documented in France and has taken many shapes and sizes, though all for slotted screws. There were large, heavy screwdrivers for building and repairing large machines and smaller screwdrivers for fine cabinet work.

Screwdrivers were very difficult to produce before the First Industrial Revolution, requiring the manufacture of a conical helix. Brothers Job and William Wyatt figured out a way to produce a screw on a new machine that first cut the slotted head and then cut the helix. Although his business failed, his contribution to the low-cost manufacture of the screw led to a huge increase in the popularity of the screw and screwdriver. The rise in popularity gradually led to the refinement and eventually diversification of the screwdriver. The refinement of screw precision also contributed significantly to the explosion in production, most notably by increasing screw efficiency and standardizing sizes, important precursors to industrial manufacturing.

The handle and shaft of screwdrivers have changed considerably over time. Design is influenced by purpose and manufacturing requirements. The “Perfect Pattern Handle” screwdriver was first manufactured by HD Smith & Company, which operated from 1850 to 1900. Many manufacturers adopted this handle design. The “flat blade” screwdriver was another design composed of forged steel with riveted wooden handles.

The shape and material of many modern screwdriver handles are designed to fit comfortably in the user's hand, for user comfort and to facilitate maximum control and torque. Designs include cutouts for the wearer's fingers and soft material surfaces, such as thermoplastic elastomer, to enhance comfort and grip. Handles composed of rigid plastic and rubber are also common. Many screwdriver handles are not smooth and are often not round, but have flats or other irregularities to improve grip and prevent the tool from rolling when on a flat surface.

Some screwdrivers have a short hexagonal section at the top of the blade, adjacent to the handle, so that a ring wrench or an open wrench can be used to increase the applied torque. The offset screwdriver has a handle set at right angles to the small blade, providing access to tight spaces and giving extra torque.

### ANALYSIS OF THE STATE OF THE TECHNIQUE

In a search carried out in specialized databases, documents were found referring to screwdrivers, such as document No. BR 11 2016 030781 0 which deals with a “SCREWDRIVER”, the present invention refers to a screwdriver including a handle (102) having a cable channel (124) extending therethrough and a shaft (104) extending from a proximal end (128) that can be inserted into the cable channel to a distal end (130) including a drill opening (137) sized to receive a proximal portion of a drill therein in communication with a locking sleeve (106) that slideably receives the shaft therethrough and is positionable over the shaft distally from the handle and a spring (170) slidably received in the locking sleeve groove on the shaft. A coupling element received over the shaft distally from the locking sleeve is movable in a first tensioned configuration in which a locking element (166) projects radially into the drill opening for lockably engaging a drill (180) received therein and a second configuration in the which the coupling element is proximally retracted to compress the spring and to allow the locking element to move radially outward from the drill opening to allow the drill to be removed therefrom. Document No. PI 9103054-4 dealing with a “SCREWDRIVER WITH PALM PROTECTION”, invention patent for a new screwdriver model; the protector (2) stands out from it, a piece that does not modify the external structure and mechanical-manual performance; it differs from the others because it does not blister the palmar skin due to the immobilization of the protector (2), built into the top of the handle (1); it is the “primus inter pares” part of this new model; the protector (2), responsible for preventing palmar blistering when screwing, squeezing or tightening, etc., remains immobile if compressed; it just slides downwards, resting on top of the sphere (6), where, nestled on the surface of the same, when the tool is turned, it avoids blisters and calluses—tilomes—in the hands of carpenters, joiners, mechanics, etc., by motionless; the protector (2), embedded in the cable (1), is held by the locking pins (4), coupled to it; the light expansive spring (3), also coupled to it, compresses the locking pins (4) against the walls of the “chamber”, keeping the protector (2) trapped there by the obstruction of the “collar”; the strong expansive spring (5), located in the “chamber” and under the protector (2), involving the ball (6), expands as soon as the compression of the protector (2) ceases, pushing it upwards, to its position initial.

Document No. MU 7302122-9 dealing with a “SCREWDRIVER ARRANGEMENT”, this utility model refers to the new constructive arrangement introduced in a screwdriver, with a ratchet-type internal mechanism and an innovative format hand-tailored cable. The arrangement comprises a metal rod (2) which projects from the hub (6) which is integral with the cable (3). The hub (6) has an internal mechanism, ratchet type, composed of a crown (4) attached to the handle (3) and a crown (4′) attached to the rod (2). A spring (5) keeps the crowns constantly apart.

Although there are numerous models of screwdrivers available on the market, there is no tool on the market that aims to screw or loosen all existing screwdrivers, leading the user to obtain a specific wrench for each screw model, increasing significantly its cost and space to store the keys.

Thus, it is a fact that the documents cited in the paragraphs above, despite belonging to the same field of application, do not present any of the characteristics of the object now perfected, thus guaranteeing that it meets the legal requirements of patentability.

### BRIEF DESCRIPTION OF THE INVENTION

Taking into account all the problems that were presented in the state of the art, the inventor, who has notorious knowledge about the sector, created and developed the aforementioned “UNIVERSAL SCREW WRENCH AND ITS RESPECTIVE USE”, which aims to screw or loosen the screws.

The objective of the present invention is to present a universal wrench, which conforms to the most varied models of screws, allowing the user to screw or loosen the screws with the same tool, saving on the cost of obtaining different wrenches and also space saving to store the tools.

The solution optionally features an internal magnet, which makes it possible to leave the magnetic tip after molding, to keep the screw close to the tip, preventing it from falling out. Said invention can optionally receive other low melting temperature materials, in place of the shown low melting temperature metal.

Said invention optionally has other low-temperature metal heating methods, such as heating by burning fuel or by electromagnetic induction, among others.

This wrench can also optionally be made in an “L” shape, serving as a support for performing the torque when tightening or removing the desired screw.

Optionally, this film can be removable, for replacement in case of wear over time of use. Also optionally, the invention presents a pressurization system, which eliminates the need for a film, keeping the metal in the liquid state trapped inside the encapsulation support by means of pressure.

### DESCRIPTION OF FIGURES

To complement the present description in order to obtain a better understanding of the characteristics of the present invention and in accordance with a preferential practical implementation of the same, the attached description is accompanied by a set of drawings, where, in an exemplified manner, although non-limiting, if it represented its operation:

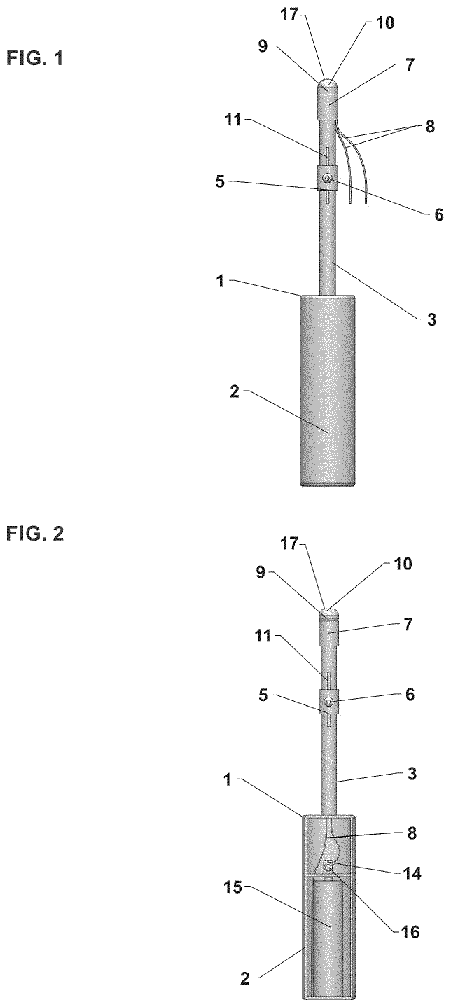

1. FIG. 1 illustrates an image of the universal key;

2. FIG. 2 shows a front view of this universal wrench, optionally with an internal heating system;

3. FIG. 3 shows a perspective view of the universal key before casting the film and low melting metal;

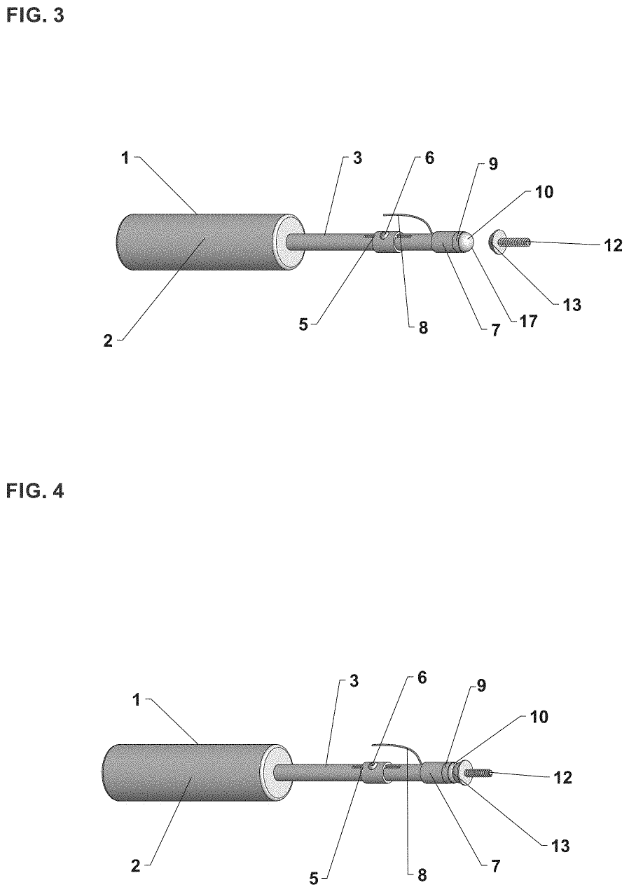

4. FIG. 4 shows a perspective view of the film and the low melting temperature metal being molded;

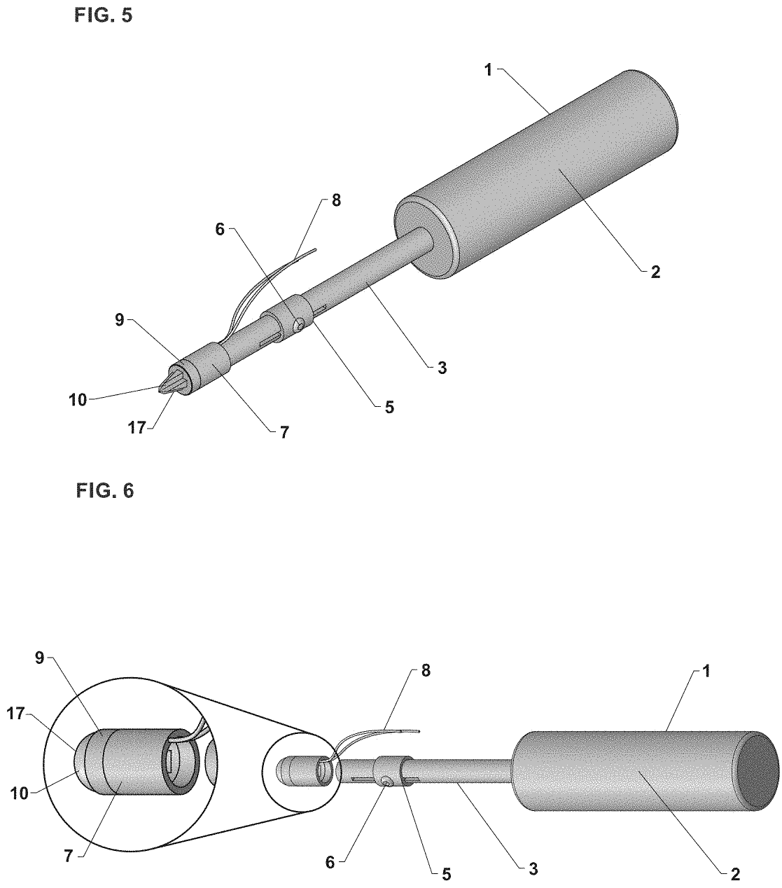

5. FIG. 5 shows a perspective view of the molded film and low melting temperature metal, and the ready-to-use tool; and

6. FIG. 6 illustrates a perspective view of the universal key, showing the possible removal of the resistor.

### DETAILED DESCRIPTION OF THE INVENTION

With reference to the illustrated drawings, this patent refers to the “UNIVERSAL SCREW WRENCH AND ITS RESPECTIVE USE”, more precisely, it conceives a screwdriver (1) of screws (12), consisting of a handle (2) or which the user holds with his hands, obtaining sufficient firmness for tightening or loosening the screw.

Said cable (2) has a hollow rod (3) at its upper end, which has a spring (11) inside, which presses an internal piston (5) activated by a button (6). The solution provides on the hollow rod (3) a removable resistance (7) heated by wires (8) and contains an encapsulation support (9), which receives the low melting temperature metal (10) and the film (17) which prevents the molten metal (10) from spilling when the tool is tilted during molding.

The invention receives the low melting temperature metal (10) and the film (17) on the encapsulation support (9). The low melting temperature metal (10) is heated through the resistance (7) that receives the external energy through the wires (8), obtaining the total melting of the metal (10) filling the square opening of the encapsulation support (9) responsible for pulling the metal (10) onto the screw (12). Then the resistance (7) is turned off, leading to the beginning of the cooling and hardening of the low melting temperature metal (10) and the film (17). After melting the metal (10), the user approaches the wrench (1) to the upper end of the screw (12) to be screwed or removed, so that the film (17) and the melted metal (10) touch each other to the cavity or shape (13) of the screw (12). Said user in turn presses the button (6), releasing the drive of the internal piston (5) on the film, pushing it on the cavity or format (13) of the screw (12) obtaining the same format. Then, the spring (11) is activated to retain the piston (5) and the user must wait until the complete cooling and hardening of the low melting temperature metal (10) and the film (17) to be used in the screw. intended.

The solution optionally contains a heating system (14) through a battery (15) located inside the cable (2), which heats the resistance (7) and energizes the switch (16), leading to interiorization wires (8), not requiring external power.

Optionally, the invention is made without the internal piston (5) and the spring (11) that performs its retraction after use, through direct exposure of the low melting temperature metal (10) and the film (17) on the encapsulation support (9), being pressed directly onto the screw, obtaining its shape.

It is certain that when the present invention is put into practice, modifications may be introduced with regard to certain details of construction and shape, without this implying a departure from the fundamental principles that are clearly substantiated in the set of claims, being it is therefore understood that the terminology used was not intended to be limiting.

1) “UNIVERSAL SCREW WRENCH”, conceives a screwdriver (1) of screws (12) composed of a handle (2) which the user holds with his hands; characterized in that said cable (2) has a hollow rod (3), which has a spring (11) inside it that presses an internal piston (S) activated by a button (6); provide on the hollow rod (3) a removable resistance (7) heated by wires (8); the resistor (7) contains an encapsulation support (9) receiving the low melting temperature metal (10) and the film (17).

2) “USE”, according to claim 1; characterized by receiving the low melting temperature metal (10) and the film (17) on the encapsulation support (9); the low melting temperature metal (10) is heated through the resistance (7) which receives the external energy through the wires (8) obtaining its total melting, filling the square opening of the encapsulation support (9); the resistance (7) is turned off; the user approaches the key (1) to the upper end of the screw (12) to be screwed or removed, so that the film (17) and the molten metal (10) rest against the cavity (13) of the screw (12); said user pressing the button (6), releasing the actuation of the piston (S) on the film, pushing it over the cavity (13) of the screw (12) obtaining the same format; the spring (11) is activated to retain the piston (5); the user waits until the complete cooling and hardening of the low melting temperature metal (10) and the film (17), in order to be used in the intended screw.

3) “UNIVERSAL SCREW WRENCH”, according to claim 1; characterized by optionally containing a heating system (14) by means of a battery (15), located inside the cable (2), which heats the resistance (7) and energizes the switch (16), leading to the interiorization of the wires (8).

4) “UNIVERSAL SCREW WRENCH”, according to claim 1; characterized by optionally being made without the internal piston (5) and the spring (11), pressing the low melting temperature metal (10) and the film (17) directly on the screw, through direct exposure of the metal of low melting temperature (10) and the film (17) on the encapsulation support (9).
